(19) United States
(12) Patent Application Publication
(10) Pub. No.: US 2008/0201332 A1
(43) Pub. Date: Aug. 21, 2008

(54) SYSTEM AND METHOD FOR PRELOADING CONTENT ON THE BASIS OF USER CONTEXT

(76) Inventors: Steven K. Souders, Los Altos, CA (US); Matthew Jon Sweeney, Mountain View, CA (US); Tenni Theurer, San Jose, CA (US)

Correspondence Address: YAHOO! INC.;C/O DREIER LLP, 499 PARK AVENUE, NEW YORK, NY, 10022, US

(21) Appl. No.: 11/676,603

(22) Filed: Feb. 20, 2007

(51) Int. Cl. G06F 17/30

(52) U.S. Cl. 707/10

(57) ABSTRACT

The present invention relates to systems and methods for preloading one or more content items. The method according to one embodiment comprises receiving a content item at a client device in response to a first request from a user, determining a context for the user and preloading one or more components into a cache on the basis of the determined context for the user. Components from the cache are loaded in response to a second request from the user.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### FIELD OF THE INVENTION

The invention disclosed herein relates generally to loading content items. More specifically, the invention relates to determining the context of a user, such as when browsing a web page, and identifying one or more components to preload on the basis of the determined context of the user.

### BACKGROUND OF THE INVENTION

Within the framework of web browsing, a user may issue a request to a server from his or her browser for a given content item, which may be a web page, one or more components comprising a web page, or one or more components in the absence of a web page. When the user is requesting a web page, the browser retrieves the web page from the server, loading the web page and any components that the web page references. Exemplary components that may comprise a web page include images, text, video, audio, JavaScript files, VBScript files, CSS stylesheets, Flash files, etc.

Downloading components that comprise a web page impacts the response time that the user experiences, such that the more components that a page contains the longer the response time for the browser to retrieve and load the web page. It is known that downloading components comprising a web page consumes a significant portion of the total end user response time (e.g., the time taken for the browser to retrieve and load the web page in response to a user request), with a smaller portion consumed downloading the HTML document for the page the user is requesting. Providing a satisfactory response time for users is critical; especially with regard to first time visitors when expectations are set with regard to the quality of experience the user can anticipate receiving. A number of solutions are known to those of skill in the art for improving the user experience through the reduction of the number of components that have to be downloaded, although solutions proposed heretofore unsatisfactorily attempt to address this issue.

One technique for reducing the number of components that the browser must download in response to a user request involves recalling any available components from a cache that the browser maintains. In some cases, web developers may provide for the caching of components that are part of a web page. Unfortunately, a major drawback to relying on the existence of necessary components in the cache from which to load a web page is that the cache does not contain these necessary components the first time a user visits a given web page. For example, if the user has never requested a given web page, the browser has not previously download the components that make up the page and therefore cannot recall or otherwise retrieve the components from the cache. A similar situation exists after the user empties his or her browser cache, either manually or on an automated periodic basis.

According to another solution, content items are preloaded by accessing the links on the page in a sequential or parallel manner, preloading all of the components for a given web page associated with a given link. Unfortunately, if the user only selects or otherwise visits only one of the given links on the web page, many (if not most) of the preloaded components are unnecessarily downloaded. This solution is unsatisfactory for users for a number of reasons including, but not limited to, unnecessarily consuming CPU cycles and network bandwidth. The solution is also unsatisfactory for content providers as clients unnecessarily consume network bandwidth and increase server loads accessing components that the user never views or otherwise utilizes.

Thus, there is a need in the art for systems and methods that maximize the number of preloaded components that a user actually requires while minimizing the number of preloaded components never seen or otherwise utilized by the user.

### SUMMARY OF THE INVENTION

The present invention is directed towards methods and systems for preloading components that are part of one or more web pages. Embodiments of the present invention provide a contextual preloader that works in conjunction with a browser (which may be executing on a client device of the user) to download components so that they are available from a cache to which the browser has a high speed connection, e.g., located local to the browser, before or at the time at which the user requires the components. The contextual preloader may be part of a browser, provided to a browser as a web service or combinations thereof.

According to one embodiment, the invention is directed towards a method for preloading one or more content items that comprises receiving a content item at a client device in response to a first request from a user, determining a context for the user and preloading one or more components into a cache on the basis of the determined context for the user. Components from the cache are loaded in response to a second request from the user.

Determining the context of a user may comprise determining a target URL, which may identify a content item that the user is likely to select to load subsequent to the content item that the user is currently viewing. Accordingly, the second request from the user may be for a content item located at the target URL. According to one embodiment the target URL identifies a web page located at the address of the target URL.

The step of determining the context of the user may also or alternatively comprise determining whether a contextual preload condition has been satisfied and, upon satisfaction of the contextual preload condition, determining a target URL. The browser loads the content item located at the target URL and caches one or more components located at the target URL. According to one embodiment, the browser loads the target URL in an off-screen frame. Alternatively, or in conjunction with the foregoing, a list of components may be retrieved for preloading from the target URL, with the contextual preloader loading the components from the retrieved list into a cache.

Determining the context of the user may also comprise issuing a call to a contextual preload web service, identifying components for preload and caching the identified components. Caching may comprise storing the components in a network-based cache. The cache may also be located local to the browser or other client components. The identified components are loaded from the cache in response to the satisfaction of a contextual preload condition.

Embodiments of the present invention are also directed towards a system for preloading one or more content items. A system according to one embodiment comprises a browser operative to receive a content item in response to a first request from a user, a contextual preloader operative to determine a context for the user and preload one or more components on the basis of the determined context for the user, and a cache operative to store the one or more preloaded components. The browser may be operative to retrieve the one or more preloaded components from the cache in response to a second request from the user and the system may also comprise a content provider operative to provide one or more content items to the browser.

The contextual preloader may be launched in response to the receipt of the content item by the browser and is operative to determine the context on the basis of the content item. Similarly, the contextual preloader may be operative to determine the context on the basis of a user interaction with the content item, wherein interaction with the content item may comprise selection of a given component. A user identifier, as well as past browsing habits of the user, may also serve as the basis for determining the context.

According to one embodiment, the contextual preloader comprises a content determination module operative to determine the context for the user and identify a target URL, as well as a content load module operative to access the target URL to preload one or more components for storage in the cache. The contextual preloader may be hosted as a web service and accessed by the browser over a network. Alternatively, the contextual preloader may be a module of the browser, which may comprise a plug-in to the browser. The cache into which the contextual preloader loads components may be located local to the browser or located remote from the browser whereby the browser accesses the cache over the network.

### BRIEF DESCRIPTION OF THE DRAWINGS

The invention is illustrated in the figures of the accompanying drawings which are meant to be exemplary and not limiting, in which like references are intended to refer to like or corresponding parts, and in which:

FIG. 1 is a block diagram presenting a system for contextual content preloading according to one embodiment of the present invention;

FIG. 2 is a flow diagram presenting a method for contextual content preloading according to one embodiment of the present invention;

FIG. 3 is a flow diagram presenting a method for contextual content preloading where a user context is not initially known according to one embodiment of the present invention; and

FIG. 4 is a flow diagram presenting a method for contextual content preloading when a user context is known according to one embodiment of the present invention.

### DETAILED DESCRIPTION OF THE PREFERRED EMBODIMENT

In the following description, reference is made to the accompanying drawings that form a part hereof, and in which is shown by way of illustration specific embodiments in which the invention may be practiced. It is to be understood that other embodiments may be utilized and structural changes may be made without departing from the scope of the present invention.

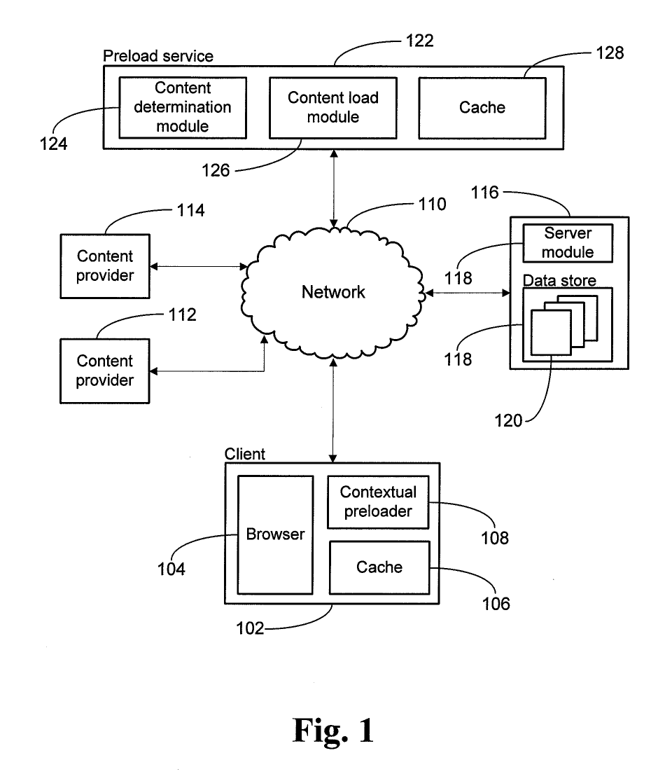

FIG. 1 presents a block diagram depicting a system for contextual content preloading according to one embodiment of the present invention. According to the embodiment illustrated in FIG. 1, a client device 102 is communicatively coupled to a network 110, which may include a connection to one or more local and wide area networks, such as the Internet. According to one embodiment of the invention, the client device 102 is a general-purpose personal computer comprising a processor, transient and persistent storage devices, input/output subsystem and bus to provide a communications path between components comprising the general-purpose personal computer. For example, a 3.5 GHz Pentium 4 personal computer with 512 MB of RAM, 40 GB of hard drive storage space and an Ethernet interface to a network. Other client devices are considered to fall within the scope of the present invention including, but not limited to, hand held devices, set top terminals, mobile handsets, PDAs, etc. It is also noted that multiple client devices 102 may be communicatively coupled to the network 110.

The client device 102 is in communication over the network with one or more content providers 112, 114 and 116. A given content provider 112, 114 and 116 may comprise a repository for the storage and transmission of one or more content items in response to a request from a client device 102. A given content provider 112, 114 and 116 may comprise a server module 118 and a data store 119, the data store operative to provide persistent storage of one or more content items. For example, a content provider 112, 114 and 116 may comprise a web site whereby the server module 118 is a web server (e.g., Apache™, Internet Information Server™, etc.) and the data store 119 is a database that maintains web pages in an organized and structured manner. The data store 119 may comprise a flat file data structure (such as a tab or comma separated value structure), a relational database, an object-oriented database, a hybrid object-relational database or other data stores know to those of skill in the art.

When a user at a client device 102 wishes to retrieve a content item from a given content provider 112,114 and 116, the user may utilize a browser 104, which may be executed locally or remotely to the client device 102. Browser technology is well known to those of skill in the art and exemplary browsers falling within the scope of the present invention include, but are not limited to, Internet Explorer™, Firefox™, Safari™, Opera™, etc. The browser 104 transmits a request over the network 110 to a given content provider 112, 114 and 116 to retrieve a given content item 120 from a data store 119 at a given content provider 116. The server module 118 at the content provider 116 is operative to mediate transmission of the content item 120 in response to the request from the browser 104. The browser 104 receives the content item 120 from the given content provider 116 and stores a copy of the components comprising the content item 120 in a cache 106 such that when the user subsequently requests the content item, the browser 104 may retrieve the components from the cache 106 and thereby eliminate the need to transmit the components over the network 110.

A given content item may comprise program code that provides a context to a contextual preloader 108, thereby allowing the contextual preloader 108 to identify and retrieve components for content items that it is anticipated the user is going to request. According to one embodiment, JavaScript code in a given content item 120 provides user context to the contextual preloader 108 to allow the contextual preloader 108 to retrieve components that the user is to require in the future, e.g., components comprising a content item that the user retrieves subsequent to viewing a current content item. According to embodiments of the invention, the contextual preloader 108 may comprise a plug-in to the browser 104, may be a stand alone application, may be a module or component deployed as part of another application or may be deployed as program code as part of a content item 120.

The following exemplary JavaScript code of Table A may invoke the contextual preloader 108 to retrieve components from a target URL:

TABLE A
ContextualPreload(“p”, “onFocus”, “http://example.com/search.html”);

The function “ContextualPreload” sets an association between the function, the page element with the identifier “p” and the “on Focus” event. Accordingly, when the element “p” generates an on Focus event, a contextual preload condition is satisfied and the contextual preloader 108 retrieves components from the target URL “http://example.com/search.html”. When the user navigates to the target URL, the browser 104 may load the components comprising the page from the cache 106, eliminating the need to communicate with the content provider 112, 114 and 116 over the network 110.

According to one embodiment, the contextual preloader 108 instructs the browser 104 to load the target URL in an invisible frame such that the browser 104 loads the components into the cache 106 without alerting the user that the contextual preloader 108 is executing. Alternatively, the content provider 112, 114 and 116 located at the target URL may return a set, list or similar manifest of components that the content item at the target URL requires. The contextual preloader 108 may utilize the list to instruct the browser 104 as to the components to retrieve from the target URL for storage in the cache 106. The contextual preloader 108 may also preload or retrieve components from the target URL for storage in the cache 106.

By way of one non-limiting example, assume that a first content item, e.g., a first web page, comprises a form to execute a keyword-based search of a corpus of documents, such as a control for executing a web search. When a user selects the input field of the form, program code in the content item 120 (such as the program code of Table A) triggers the contextual preloader 108 to be launched and provide the context of the user, e.g., about to enter a search. Alternatively, the contextual preloader 108 may determine the context of the user on the basis of the current content item or previous content items.

Continuing with the present example, program code in the content item may pass the contextual preloader 108 a target URL, as the user has satisfied the contextual preload condition of providing one or more keywords for the execution of a search. Accordingly, the contextual preloader may access the target URL and begin loading components from the target URL into the cache 106. The contextual preloader 108 may also load components into the cache in conjunction with the browser 104, such as where the contextual preloader 108 instructs the browser 104 as to the specific components to load into the cache 106.

This exemplary embodiment may be viewed in the framework of a “context” and “intent” of the user: the user is interacting with a web search form (“context”) and he or she clicked on an input filed (“intent”). When the user submits the search results, the browser 104 loads components from the cache 106 as opposed to retrieving the components from the content provider 112, 114 and 116. As the example illustrates, the contextual preloader 108 provides for the availability of one or more components from a local data source prior to the user needing a given one of the one or more components, thereby improving response time.

By way of a second non-limiting example, assume a given content provider requires the user to present proper credentials prior to the content provider 112, 114 and 116 making content items 120 available. If the user is not logged into the content provider 112, 114 and 116, the browser 104 at the client device 102 of the user is redirected to a login page where the user may provide his or her credentials (e.g., username and password) for authentication. Once authenticated, the browser 104 is redirected to the one or more content items at a given content provider 112, 114 and 116.

To increase the speed with which the browser 104 may load the content item 120 that the user is attempting to access, program code at the login page may issue a call to the contextual preloader 108, passing the contextual preloader 108 the context for the user, e.g., that the user is attempting to access a given content item at a given content provider 112, 114 and 116. Accordingly, the contextual preloader 108 may access the given content item while the user is authenticating his or her credentials and begin the process of loading components comprising the content item into the cache 106, which may also be performed with or, alternatively, by, the browser 104. When the user completes the logon process and is redirected to the given content item at the given content provider 112, 114 and 116, the browser 104 may load some or all of the components comprising the content item from the cache 106, thereby reducing or eliminating any latency penalty associated with connecting to the content provider 112, 114 and 116 over the network 110.

In addition to being run in conjunction with the browser 104 on the client device 102, the contextual preloader may be deployed as web service, e.g., preload service 122. Program code within or referenced by a content item may make a call to the preload service 102, which may comprise a content determination module 124, a content load module 126 and a cache 128. According to one embodiment of the invention, the contextual preloader 108 and the preload service 122 comprises one or more modules in common, but deployed as client side program code versus a web service, respectively.

The content determination module 124 may receive a context for a user and determine one or more components to retrieve from a given content provider 112, 114 and 116 for storage in the cache 128. According to one embodiment, the preload service is configured with a high bandwidth connection to the network 110, which may also comprise 24/7 uptime as understood by those of skill in the art, to ensure the availability of components, e.g., in the event a given content provider 112, 114 and 116 becomes unavailable. The content determination module 124 may further be operative to dynamically determine the set or list of components to preload into the cache 128 on the basis of one or more inputs including, but not limited to, context, intent, user identifier, past user behavior, historical browsing habits of the user, etc.

The content determination module 124 may pass a set or list of components to preload to the content load module 126. Alternatively, the content determination module 124 may receive a user context, including a target URL, which the content determination module may pass to the content load module 126. According to one embodiment, the content determination module 124 may determine a list of relevant components for preloading on the basis of the receipt of a context and a target URL. The content load module 126 may be operative to access one or more content providers 112, 114 and 116 and load components available at the content provider into the cache 128 on the basis of the user context or other information that the content determination module 124 provides. Alternatively, or in conjunction with the foregoing, the preload service 122 may be operative to load components available at the content provider into the local cache 106 at the client device. Additionally, the preload service 122 or the contextual preloader 108 may parse the content item at the target URL, loading only those components where a cache control header or similar information for the component (that identifies a time period to cache a given component) identifies that the component has a lifecycle that exceeds a threshold. For example, only those components are loaded into the cache that the cache control header indicates may be cached for a period of time exceeding a one day threshold.

The content determination module 124 may also build a set or list of components for the content determination module 126 to load into the cache on the basis of a user profile (not pictured) for the user. Again, components may be loaded into the cache 128 located at the preload service 122, the cache 106 located at the client device 102, or combinations thereof. Using behavioral information regarding the user, which may be stored in a cookie that the preload service 122 assigns to the user, allows the content determination module 124 to select the content providers 112, 114 and 116 the user is expected to access. This selection may also take re-visitation frequency into account.

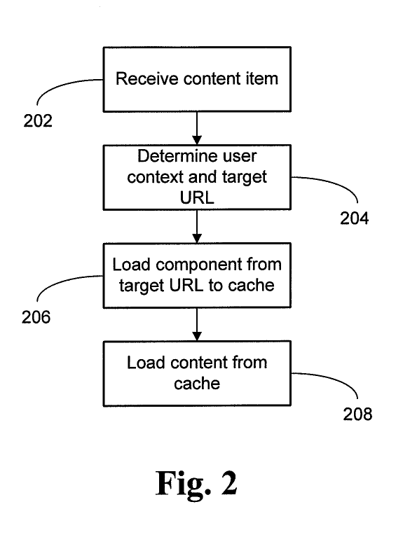

One embodiment of a method for utilizing the various embodiments of the system for contextual content preloading is illustrated in the flow diagram of FIG. 2. According to the process of FIG. 2, a content item is received, step 202, which may comprise receipt by a contextual preloader on a client device or a preload service deployed on a network and made available to content providers. User context is determined and a target URL identified from which to load components into a cache, step 204. Components are loaded from the target URL into the cache, step 206, and, when needed, are loaded into a browser from the cache, step 208, which may also comprise loading components that are unavailable in the cache from one or more content providers.

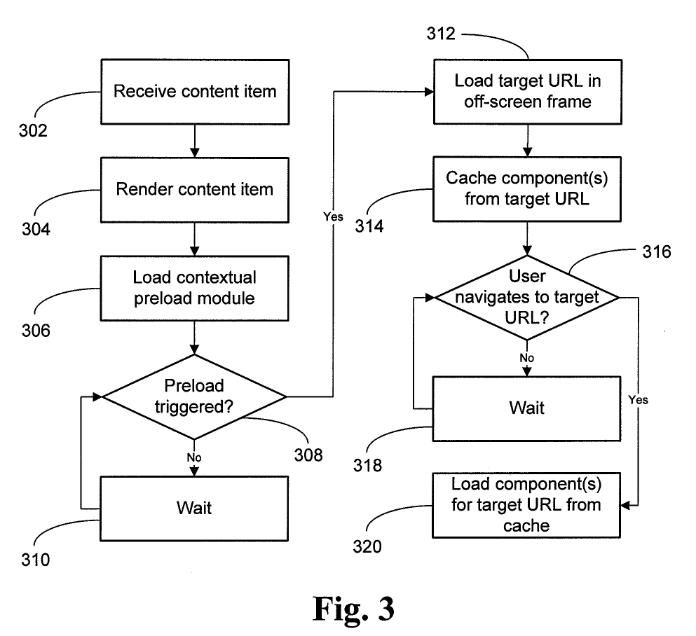

FIG. 3 illustrates another embodiment of a method for contextual content preloading. According to the embodiment of FIG. 3, a browser at a client device retrieves a content item from a content provider in response to a user, a software process, or combinations thereof, step 302. The browser receives the content item from the content provider and renders the content item on a display device in communication with the client device, step 304. If not running, the client device instantiates the contextual preloader, step 306.

The user views the page and the contextual preloader awaits satisfaction of a contextual preload condition, step 308, which may be made by program code in the content item in response to a user action. Where the user does not trigger preloading, step 308, the contextual preloader enters a wait sate, step 310, awaiting a call indicating satisfaction of the contextual preload condition, step 308. When the check at step 308 evaluates to true, program flow continues with step 312 where the contextual preloader instructs the browser to load components from the target URL in an off-screen frame, step 312. As the components load in the off screen frame, the browser may maintain a copy of the component from the target URL in a cache, step 314.

A check determines if the user navigates to the target URL, step 316. Where the user does not navigate to the target URL, step 316, the process enters a wait state, step 318. During the wait state, step 318, the user may navigate away from the current content item or browse the current content item. When the user navigates to the target URL, step 316, the browser loads from the cache any components for the content item located at the target URL that are available in the cache, step 320.

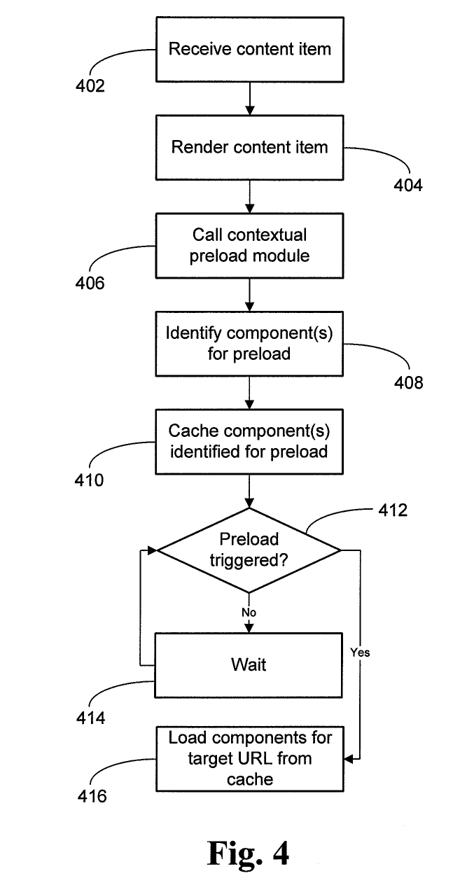

FIG. 4 illustrates another alternative embodiment of a method for contextual preloading where the context of the user is know when a content item is loaded, e.g., when providing credentials at a logon page to access a target URL. According to the embodiment of FIG. 4, a browser at a client device retrieves a content item from a content provider in response to a user, a software process, or combinations thereof, step 402. The browser receives the content item from the content provider and renders the content item on a display device in communication with the client device, step 404.

A call is made to a contextual preloader, which may be deployed as a client side module, a web service, or combinations thereof, step 406. According to one embodiment, the call to the contextual preloader comprises the transmission of a context for a user, which may further comprise an intent of the user. On the basis of the context of the user, the contextual preloader identifies components for preloading, step 408, and proceeds to cache the identified components, step 410. The contextual preloader may directly load components into the cache or may load components into the cache in conjunction with the browser.

A check is performed to determine the satisfaction of a preload condition, step 412. For example, where the content item is a logon page, the preload condition may be the authentication of a set of credentials that the user provides. Where the preload condition is not triggered, step 412, the process enters a wait state, step 414. Upon satisfaction of the preload condition, however, the browser attempts to load any components for the content item located at the target URL from a cache, step 416, and may access any unavailable components directly from the given content provider hosting the content item.

FIGS. 1 through 4 are conceptual illustrations allowing for an explanation of the present invention. It should be understood that various aspects of the embodiments of the present invention could be implemented in hardware, firmware, software, or combinations thereof. In such embodiments, the various components and/or steps would be implemented in hardware, firmware, and/or software to perform the functions of the present invention. That is, the same piece of hardware, firmware, or module of software could perform one or more of the illustrated blocks (e.g., components or steps).

In software implementations, computer software (e.g., programs or other instructions) and/or data is stored on a machine readable medium as part of a computer program product, and is loaded into a computer system or other device or machine via a removable storage drive, hard drive, or communications interface. Computer programs (also called computer control logic or computer readable program code) are stored in a main and/or secondary memory, and executed by one or more processors (controllers, or the like) to cause the one or more processors to perform the functions of the invention as described herein. In this document, the terms “machine readable medium,” “computer program medium” and “computer usable medium” are used to generally refer to media such as a random access memory (RAM); a read only memory (ROM); a removable storage unit (e.g., a magnetic or optical disc, flash memory device, or the like); a hard disk; electronic, electromagnetic, optical, acoustical, or other form of propagated signals (e.g., carrier waves, infrared signals, digital signals, etc.); or the like.

Notably, the figures and examples above are not meant to limit the scope of the present invention to a single embodiment, as other embodiments are possible by way of interchange of some or all of the described or illustrated elements. Moreover, where certain elements of the present invention can be partially or fully implemented using known components, only those portions of such known components that are necessary for an understanding of the present invention are described, and detailed descriptions of other portions of such known components are omitted so as not to obscure the invention. In the present specification, an embodiment showing a singular component should not necessarily be limited to other embodiments including a plurality of the same component, and vice-versa, unless explicitly stated otherwise herein. Moreover, applicants do not intend for any term in the specification or claims to be ascribed an uncommon or special meaning unless explicitly set forth as such. Further, the present invention encompasses present and future known equivalents to the known components referred to herein by way of illustration.

The foregoing description of the specific embodiments so fully reveals the general nature of the invention that others can, by applying knowledge within the skill of the relevant art(s) (including the contents of the documents cited and incorporated by reference herein), readily modify and/or adapt for various applications such specific embodiments, without undue experimentation, without departing from the general concept of the present invention. Such adaptations and modifications are therefore intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance presented herein, in combination with the knowledge of one skilled in the relevant art(s).

While various embodiments of the present invention have been described above, it should be understood that they have been presented by way of example, and not limitation. It would be apparent to one skilled in the relevant art(s) that various changes in form and detail could be made therein without departing from the spirit and scope of the invention. Thus, the present invention should not be limited by any of the above-described exemplary embodiments, but should be defined only in accordance with the following claims and their equivalents.

We claim:

1. A method for preloading one or more content items, the method comprising:
receiving a content item at a client device in response to a first request from a user;
determining a context for the user;
preloading one or more components into a cache on the basis of the determined context for the user; and
loading components from the cache in response to a second request from the user.

2. The method of claim 1 wherein determining the context comprises determining a target URL.

3. The method of claim 2 wherein the second request from the user is for a content item located at the target URL.

4. The method of claim 3 wherein the content item is a web page.

5. The method of claim 1 wherein determining the context comprises:
determining satisfaction of a contextual preload condition; and
upon satisfaction of the contextual preload condition, determining a target URL.

6. The method of claim 5 comprising:
loading the target URL; and
caching components from the target URL.

7. The method of claim 6 wherein loading the target URL comprises loading in an off-screen frame.

8. The method of claim 5 comprising:
retrieving a list of components for preloading from the target URL; and
preloading the components from the retrieved list.

9. The method of claim 1 wherein determining the context comprises:
issuing a call to a contextual preload web service;
identifying components for preload; and
caching the identified components.

10. The method of claim 9 wherein caching comprises storing in a network based cache.

11. The method of claim 9 comprising loading the identified components from the cache in response to satisfaction of a contextual preload condition.

12. A system for preloading one or more content items, the system comprising:
a browser operative to receive a content item in response to a first request from a user;
a contextual preloader operative to determine a context for the user and preloading one or more components on the basis of the determined context for the user; and
a cache operative to store the one or more preloaded components.

13. The system of claim 12 wherein the browser is operative retrieve the one or more preloaded components from the cache in response to a second request from the user.

14. The system of claim 12 comprising a content provider operative to provide one or more content items to the browser.

15. The system of claim 12 wherein the contextual preloader is launched in response to the receipt of the content item by the browser and is operative to determine the context on the basis of the content item.

16. The system of claim 15 wherein the contextual preloader is operative to determine the context on the basis of a user interaction with the content item.

17. The system of claim 16 wherein interaction with the content item comprises selection of a given component.

18. The system of claim 12 wherein the contextual preloader comprises:
a content determination module operative to determine the context for the user and identify a target URL; and
a content load module operative to access the target URL to preload one or more components for storage in the cache.

19. The system of claim 18 wherein the contextual preloader is hosted as a web service and accessed by the browser over a network.

20. The system of claim 18 wherein the contextual preloader is a module of the browser.

21. The system of claim 20 wherein the contextual preloader is a plug-in to the browser.

22. The system of claim 12 wherein the cache is located remote from the browser and the browser accesses the cache over the network.
